(19) United States
(12) Patent Application Publication
(10) Pub. No.: US 2012/0089465 A1
(43) Pub. Date: Apr. 12, 2012

(54) Activity based mobile ad system and internet business model

(76) Inventor: Walt Froloff, Aptos, CA (US)

(21) Appl. No.: 12/924,839

(22) Filed: Oct. 6, 2010

(51) Int. Cl. G06Q 30/00

(52) U.S. Cl. 705/14.71

(57) ABSTRACT

An activity based mobile application system and Internet business model is described. The ABMAS harnesses a diverse set of mobile device apps sensing mobile user activity with a sponsor ad auction engine. The disclosed mobile ad system allows sponsors to identify and bid on mobile ad placement to motivated buyers in need of sponsor products or services as perceived to exist from performance of specific activates. The bid winning ads are sent to mobile users located within a selected range from sponsor fulfillment station within an auction site region, whereby mobile app users in performance of some activity become motivated, triggering needs for vendor ad offerings while the user's need initiation and motivation is temporally and geographically proximate to the vendor for fulfillment of the mobile app user's needs.

### BACKGROUND

### Field of the Invention

The present invention generally relates to identifying user actionable needs through mobile device application sensed activity and facilitating proximate vendor ad placement targeting those specific and particular needs as they reach sponsor selected activity and activity thresholds. More specifically, a mobile user's physical activity is monitored by an executing mobile app. Mobile ad sponsors bid on users specific activities and activity levels for ad placement into the mobile apps once the sponsor bid activity thresholds are achieved by mobile app users and the users are sponsor select proximate to the sponsors fulfillment location.

The onset of smart phones has seen a proliferation of Location-Based System, LBS, business models which are used in a variety of contexts, such as health, work, personal life and many others. LBS models can include services to identify a location of a person or object, for such things as discovering the nearest banking cash machine or the whereabouts of a friend or employee. An LBS can include mobile commerce when taking the form of coupons or advertising directed at customers based on their current location. LBS can include personalized weather services and even location-based games.

One of the fastest growing LBS applications is mobile advertising, although generally more expensive than comparable online advertising. Mobile ad models provide expensive high value ad placement systems and in most instances are not yet competitive with comparable online advertising in price, nor are they superior in advertising power.

In mobile advertising markets, mobile ads are most commonly seen as a Mobile Web Banner, top of page banner, or Mobile Web Poster, bottom of page banner, while in others, it is dominated by SMS advertising. SMS or texting is the most widely used data application in the world, with 2.4 billion active users. Other forms of mobile ads include MMS advertising. Multimedia Messaging Service, is a standard way to send messages that include multimedia content to and from mobile phones. It extends the core SMS capability which only allowed exchange of text messages up to 160 characters in length. The mobile ad business models today are mainly statistical where only a small fraction find are timely and locally delivered, finding motivated customers. What is needed are more targeted mobile ad approaches, where the ads are informing “motivated customers” of a way to resolved a present need in real-time. When the mobile ad has a low click through rate, it is due to the lack of ad persuasion for any number of reasons. So, current mobile ads fail to be informative. Most current mobile ads fail in this mission because the information is not timely or not convenient. What is needed is higher percentage of click-through, stimulating less expensive mobile ads that can leverage the less expensive ad technologies by finding more likely-to-purchase vendor amenable customers

MMS advertising occurs within mobile games and mobile videos, during mobile TV receipt, full-screen interstices. These appear while a requested item of mobile content or mobile web page is loading up, and audio advertisements that can take the form of a jingle before a voicemail recording, or an audio recording played while interacting with a telephone-based service such as movie ticketing or directory assistance. The most popular MMS use is to send photographs from camera-equipped handsets, although it is also popular as a method of delivering news and entertainment content including videos, pictures, text pages and ringtones.

However, these are all one-size-fits-all ads in that there is nothing that is personally or physically distinguished from the mobile users besides the users location, so the ad targets are those that have a particular location, carrier service or cellphone vendor and not much more, to give any indications as to what the user's present needs. To purchase and send an ad, currently one must only be able to reach a mobile phone with an advertisement. What is lacking is the consumer's interest or need component and user's motivation to read the ad, which explains the low click-through rates of most current solutions. What is missing in the advertising model equation is the mobile app users current needs. What is needed is a mobile advertising model that account for a user's personal feelings, which discovers particular user needs, which sponsor's can identify and address. Under those user feeling states, mobile ads become informative messages of particular interest on options for pressing present decisions on the mobile user. What are needed are mobile ad services that place mobile ads based on immediate, personal and specific customer needs.

LBS in mobile advertising is expensive and revenue generated from ads is not generally sufficient to cover the cost for things like navigable maps and other expenses. Hence most sponsors must have large marketing budgets that expect low click through low user read rates. What is needed for LBS are competitive ad business models from the local ad sponsor as well as the national ad sponsor.

Ad based LBS requires maintenance, improvement and updating. While subscription models dominate the LBS ad space, with the largest carriers offering unlimited pricing plans, the ad service may have the image of being free to the customer as it is lumped in with data services or free apps. To many consumers, ads are a necessary evil, one to be tolerated. Thus the blind posting of advertisement on the mobile in the hopes of finding interested customers regardless of consumer's disposition or need to visit a specific merchant's establishment or sample sponsor's product is averted. What are needed are competitive priced ad services carrying user needed informative ads. What is needed is higher granularity or “pin-point-customer-ad” targeting, not a “blanket-mobile-ad-user-need” which is user accepted spam. In addition, precision targeting will address only those users with specific needs in a geographic area, reducing the number of ads that need to be served up to mobile phones substantially. Consumers don't buy things all day, but there are certain predictors of a buy action and that is what is needed, ads which respond to a buy action.

The issues with all of the present LBS ad models is how much revenue can be generated at a price for profit in the mobile ad space. This is limited by what the consumers' tolerance is for the advertising on their mobile device. Consumer tolerance is based on consumer's interest and benefit accrued for the perceived nuisance of ad interruptions. Purely unwanted advertising is considered a nuisance and quickly gets turned off, tuned out or deleted like spam. The challenge then becomes how to send an ad to an interested mobile user or very motivated consumer, motivated for the particular product or service that the ad promotes. Additionally, the ad sponsor must identify motivated potential customers for the ad placement. For example consumers are not motivated to pay much attention to a car ad if they are not in need of or planning to purchase a motor vehicle. An ad to that consumer would be considered spam. Customers are not motivated to buy gas, beer, a coffee or lunch unless it's the proper time, and that is when they are running out of fuel, need to relax, are tired, uncomfortable or hungry respectively. Few things are more annoying than a mobile ad taking over the screen to in the middle of a user's app session. And this is the challenge, getting notice of just when the customers needs arise and instantly responding with the remedy in the ad product/service. But that is where and when the customer motivation is piqued and chances of consummating a transaction maximized. What is needed are intelligent LBS business models that can pin-point the time and place of these customers and introduce them to ad sponsors of the kind that fit the identified potential and very motivated customers.

Mobile ad pricing strategies by the owners of the mobile ad agencies favor very large companies with million dollar marketing budgets. Some advertisers must pay twice, cost-per-click on top of a cost-per-thousand fee. Some of these demanded budgets are north of $1 million, an usually large sum for mobile ad buys. This prices the small businesses out of some ad markets from the start. What is needed are models more like the Google® Adword® model that allows for individuals and small business entities with medium size marketing budgets to use mobile ads for the mobile market.

The large mobile ad models facilitate integrating advertisements into mobile applications downloaded. If the user taps on an ad banner displayed in the mobile app, a full-screen advertisement appears within the application. This is different from other ads that may send the user into a web browser. Here the ads must be more interactive than on other advertising services, because users have a lower tolerance for ads while engaged in an app. Under these mobile ad models, typically the ad agency retains 40% of the ad revenue with the other 60% going to the app developer. These generally require large market campaign budgets. What is needed are ad business models that allow smaller sponsors and better identified higher value potential customers to be found by smaller business entities in more localized a.

Mobile users are typically on the move, or doing physical exercise or engaged in some activity which generate sensed data while executing their mobile apps. When this user activity is within proximity to a businesses set up to facilitate or enhance that activity or activity conclusion, an opportune advertising situation exists, because at some point in time needs arise naturally and need to be fulfilled. What is needed are mobile ad models that connect consumers with real-time specific needs with businesses of goods and services that can timely fill those needs at a place and time mutually convenient for both parties.

Sophisticated sensors including 3D accelerometers, compasses, gyroscopes and more are finding their way into smart mobile phones. This has created a powerful opportunity for mobile app developers measuring and reporting on physical activity, an activity that naturally requires additional products or services for the users advantage or resolution. What is needed are ways to identify motivated perspective customers through sensor technology monitoring and reporting user activity.

Because mobile device functionality and speed are increasing and also becoming faster, there are many reasons that consumers are using their mobile devices for more than just phone communication. Mobile app developers have grown exponentially in numbers, producing more and better mobile apps measuring and tracking mobile user activity through their apps. This has increased LBS business models and have helped to propel mobile advertising. Concurrently, mobile app developers have created a new world of tools and utilities from software that replace real actual hardware tools and devices. These include, besides the obvious phone, such things as a compass, a level, measuring ruler, light, mirror, pedometer, speedometer, odometer, altimeter, camera, video recorder, GPS map guide, dictionary, thesaurus, voice recorder, dictaphone, GPS tracker, board games, virtual games, adventure games, sports measuring devices, and more. The app list is also growing exponentially and the creativity limits are only those of imagination. Many of these utility apps sense and log activity from their use. This data provides sources of needs at various threshold usage level. What is needed are advertising schemes which use the “mobile-app-sensor-data” providing user needs from activity or use levels so that they can be timely and efficiently met by those in proximity to do so.

Mobile apps for activities such as golfing, base ball, cricket, tennis, hiking, jogging, running, walking, GPS tracking, GPS driving, jump rope, volley ball, table tennis, virtual mobile games, arcade games are also proliferating to all of the smart phone app development platforms.

The mobile device apps in the area of consumer activity or physical exercise contains a large diversity of products and services. This phenomena is getting much traction in mobile applications. What are needed are LBS mobile ad models that find consumer needs where and when they occur so as to more efficiently bind buyers and sellers, customers and merchants in affordable ways. Competition for ad prices to ad sponsors for specific perspective customers can keep prices competitive.

Privacy issues are beginning to surface on the mobile devices. Advertisers are turning to all manner of tracking mobile users. Some have even turned to using Flash® cookies to re-spawn deleted cookies. Although this practice of using Flash cookies to re-spawn deleted cookies has been condemned publicly by Adobe® and the Network Advertising Initiative, an industry group, the tracking industry is increasing because the drive by advertisers to gain advantage using the mobile technology is increasing exponential to catch up with the mobile market's exponential growth. However, simply knowing which websites are visited or where the mobile user has been are not very effective for finding mobile user needs. The conventional marketing approach must then still fall back on spamming the mobile user with ads based on where they have been in cyberspace or presently located, LBS models. What is needed are mobile ad placement methods and models based on what potential customers are likely to need and when they are likely to them instead of when and where vendors can aggressively and most user intrusively sell.

### SUMMARY

The present invention discloses a system and Internet business model for coupling a plurality of mobile device applications sensing mobile user activity for an ad auction. The mobile device app developers register created mobile apps with an activity ad model API website for downloading and executing on mobile devices after establishing data connectivity with the activity ad auction model API serving website. The user mobile executing apps report app data for at least one activity to ad activity auction API website, which monitors app location, receiving, storing and managing API registered mobile app activity over a geographical region. A plurality of mobile ad sponsors set bids on user mobile app selected activity levels at the API serving auction. The sponsor auction bids on activity thresholds and when achieved by mobile app activities trigger an ordered hierarchy of sponsor ads to be sent to the mobile app user devices. The bid winning ads are sent to mobile users located within a selected range from sponsor fulfillment station, whereby mobile app users in performance of some activity become motivated, triggering needs for vendor ad offerings while the user's need initiation and motivation is temporally and geographically proximate to the vendor for fulfillment of the mobile app user's needs.

### BRIEF DESCRIPTION OF DRAWINGS

FIG. 1 is a high level block diagram illustrating the activity based mobile app ad business model according to an embodiment of the present invention.

FIG. 2 shows exemplary mobile device user within proximity of local merchants bidding for ad placement on mobile user's app for a selected period of time according to an embodiment of the present invention..

FIG. 3 is a flow diagram showing mobile app Activity Based Mobile App Service process for collecting and using user activity data according to an embodiment of the present invention.

FIG. 4 is a diagram showing example mobile apps and their associated user interfaces for providing sensed activity data to the user in according to an embodiment of the present invention.

FIG. 5 is a diagram showing a hiker/biker tracker mobile app user interface with a example hierarchical mobile ad rendering in according to an embodiment of the present invention

FIG. 6 is an exemplar vender interface for registering business information and activity bids on the model website according to an embodiment of the present invention.

FIG. 7 is list of mobile sensor created mobile application activity which can be transmitted to a model website according to an embodiment of the present invention.

FIG. 8 is an exemplar API for mobile application creators for registering and integrating their apps with a model website according to an embodiment of the present invention.

### DETAILED DESCRIPTION

Specific embodiments of the invention will now be described in detail with reference to the accompanying figures.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### OBJECTIVES AND ADVANTAGES

Mobile user app activity levels generate real-time needs which provide motivation for as near immediate as possible fulfillment. Thus great motivation by user generally exists for proximate vendor product or service satisfying consumer present activity level spurred needs. However many local merchants, vendors, businesses can vi for the same proximate potential customer. An auction for the potential clients attention is a reasonable method of injecting competition into an advertising model which can be fair to all ad sponsor-vendors, with a winning vendor's bid sending an ad to the consumer which lasts for the vendor duration selected.

The present invention is a system and method of improving advertizing placement by co-coordinating and connecting real-time consumer needs with consumer proximate vendors fulfilling these real-time needs through specific product or service solutions which are timely and conveniently near the mobile using consumer.

Applying activity and location based advertising by identifying consumer's with needs and fulfilling those needs through consumer proximate merchants and vendors is a strategy of amplifying likelihood of transaction between interested buyers and sellers. The basic principle follows that consumers purchase vendor product/service as a result of consumer activity when reaching a threshold leaving the consumer sufficiently tired, hunger, thirsty, frustrated, happy, energized, and thus perhaps more motivated to satisfy the immediate pressing need to resolve the intensity through a convenient source, a proximate fulfiller.

Physical activity is by its nature a hands and body occupying activity. Therefore, devices with sensors that track and register activity will have an advantage knowing when consumers needs become motivators for consumer's decision to need fulfillment. However, there are many creators of mobile applications and many types of activities. No single mobile app developer can hope to create all of the applications that serve the gamut of possible human activities. Hence a community of app develops can register their apps with the invention Activity Based Mobile Ad Service (ABMAS) model for the business of auctioning mobile user proximate vendor's mobile ads to motivated mobile users for fulfillment of present user needs at proximate business product or service locations.

It is an object of the invention to use any and all mobile apps that sense, calculate and report usage or user activity in any measure for the purposes of identifying realtime consumer needs.

It is another object of the invention to identify consumers motivated to find fulfillment from physical activity spurred needs, at a location temporally proximate to the establishment of those needs and introduce them through ads, to providers and vendors in the occupation or business of fulfilling those specific and particular needs related to the activity or usage registered by the mobile app.

It is yet another object of the invention to give vendors or seekers of consumers for their products and services, to establish a competitive advertising alternative on mobile devices.

It is another objective of the invention to provide a means for individuals or businesses to find local and proximate measurably motivated consumers for their products or services.

It is yet another objective of the invention to provide individuals and businesses to give potential customers timely notice of their offerings through customers engaged mobile apps.

It is an object of the invention to connect as many mobile apps as can be harnessed to provide user activity data which will represent a good segment of a population's activity. This may require building a community of mobile app developers through various business models.

It is an objective of the invention to provide mobile devices with ad to individuals with a specific and personal need in the product/service advertised, ie to have provide identification efficiency of target market near 100%.

It is another objective to provides ads to consumers at the exact time of need for prod/service, so as to provide the vendor with maximum consumer motivation for purchase and without burden of consumer search.

It is another objective of the invent to provide flexibility to advertiser's to send ads only interested consumers located within selected space and time proximity.

It is another objective of the invention to provide flexibility of advertiser to bid for ads by consumer activity performance.

It is yet another objective of the invention to provide advertisers with the ability to synchronize advertising budgets with business growth resulting from ads.

It is another objective of the invention to provide advertiser capability to advertise with even the smallest of ad budgets.

It is an objective of the invention to reduce the clutter of ads to consumers by sending only those ads which could be of personal, material and substantial use to the consumer, not a spam on a particular demographic.

Figure Details

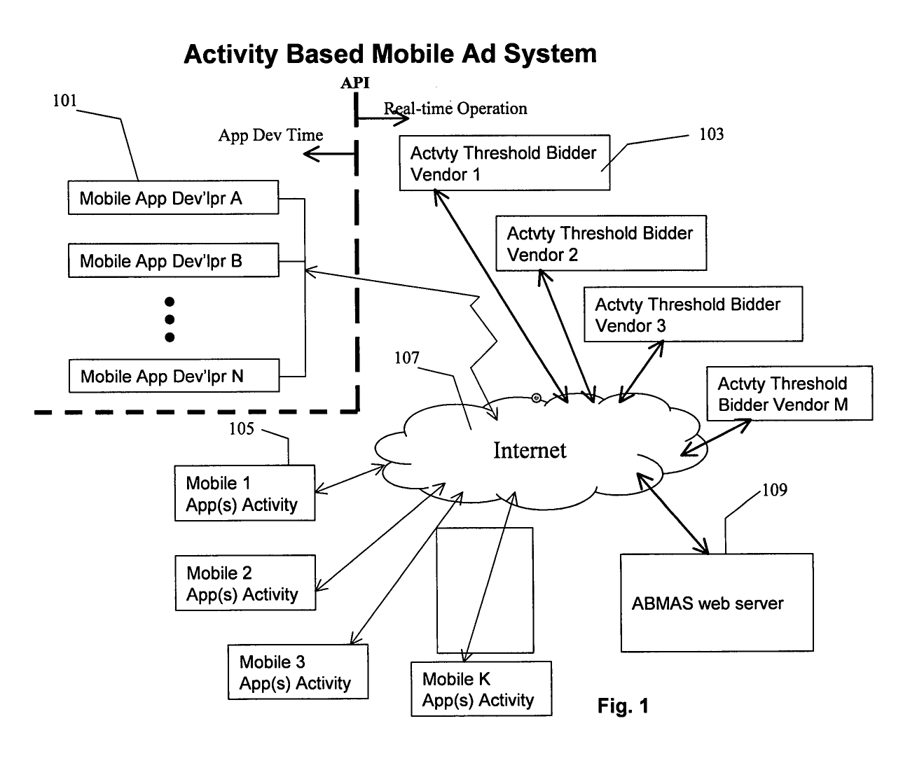

FIG. 1 is a high level block diagram illustrating the activity based mobile app ad business model according to an embodiment of the present invention.

Mobile App develops 101 receive AMBAS 109 API instructions and build mobile apps in compliance with that API. The mobile apps are then downloaded by Mobile App Users 105 at which time app users 105 execute the apps at will. Mobile App users 105 are motivated to use the downloaded and upon execution and authorization, the user apps 105 report activity parameters characteristic of the app to the AMBAS 109 website via the Internet 107 or other intermediary network. Activity data is collected, organized and stored on the AMBAS 109 servers in real-time along with the mobile app 105 location while the app is in use. Asynchronously and independently, venders 103 seeking to advertise to proximate mobile user 105 customers register with the AMBAS 109 service and bid on user activity types and usage levels of the magnitude that will likely render the app users 105 in a state motivated for the purchase of the vendors 103 offerings of products or services. User 105 location and activity data is compared with the vendor 103 set location radius and bid type and threshold levels, the ABMAS 109 respectfully. Users 103 within a winning bid vendors set radius with activity above the set thresholds will trigger an ad being sent to the user 103 mobile app.

The mobile devices 105 execute mobile applications measuring realtime activity data, trigger upon winning vendors 103 bid for ad placement by the ABMAS service, accepting vendor performance set limits and bids. The vendor 103 is then charged the bid amount for each sent ad. The winning vendors ad is then sent when the user 105 is within vendor set radius of mobile user 105 for a duration proportional to the time that the user will be proximate to the vendor 103. In thus fashion vendors bidding on the ABMAS 109 service with performance triggering ads only act when the users activity indicates a motivated customer and while user 105 is proximate to the vendor 103. User 105 newly created needs in performance of some activity arise from a depleting activity(ies) requiring timely need resolving products or services. Hence an ad offerings of products and services just prior to users need resolution is more material in the decision because the ad information is fresh and upper most in users memory. The as information then has a higher likelihood of being put to immediate use in developing resolving consumer options in resolving needs. An ad placement then is not only more displayed to a more motivated view, but the proximity of the vendor to fulfill the need then and there, solves the two biggest issues for transaction consummation as a result of advertising.

Mobile Apps

Not all mobile apps use the mobile device sensors to provide clues about mobile user 105 activity but many do. Examples of some apps that use mobile device sensors are: golf, base ball, cricket, tennis, hiking, jogging, running, walking, GPS tracking, GPS driving, jump rope, exercise, volley ball, table tennis, virtual mobile game, mirror, compass, level, measuring tape, video, movies, TV Guide, pedometer, speedometer, photography and more. It would almost appear the apps are only limited by imagination, as they are creative, useful and exponentially increasing.

Mobile apps report activity in many ways. Some example measures are: swings, swings/minute, swing velocity/acceleration, swing duration-stop/start, activity time-current/ start, jumps, jumps/hour, distance walked/jogged/run/biked, velocity, acceleration duration, kills, kills/hour, thefts/hour, hits, hits/time, hits*time, group hits/time/holes/swings, blemishes/inch and more. This increases daily with new apps and even an apps repeated or periodic use can be an activity for the purposes of a vendors ad criteria and will thus improve the activity space and hence the target ad precision and accuracy. Thus activity thresholds bidders 103 may not be aware of all of the activities that may characterize their most likely and needful customers. Therefore the ABMAS 109 service may provide various forms of activity threshold search features.

There is a distinction to be made between sensed, measured, monitored and reported registered mobile app activities from user apps 105 and the thresholds set on those by bidding vendors 103. The first is reported data from users 105 and the second is bidding requirement data from ad sponsors 103. The AMBAS 109 model operates on the user 105 activity data to provide the AMBAS 109 the capability of identifying vender product/service motivated consumers in real-time and for sending the ads to users 105 at those motivated periods.

The activity based mobile ad Internet business model coordinates communication from a plurality of mobile device applications sensing mobile user activity for an ad auction. The mobile device app developers register created mobile apps with an activity ad model API website for downloading and executing on mobile devices after establishing data connectivity with the activity ad auction model API serving website. The user mobile executing apps report app data for at least one activity to ad activity auction API website, which monitors app location, receiving, storing and managing API registered mobile app activity over a geographical region. The mobile ad sponsors set bids on user mobile app selected activity levels at the API serving auction. The sponsor auction set bids on activity thresholds and when achieved by mobile app activities, trigger an ordered hierarchy of sponsor ads to be sent to the mobile app user devices. The bid winning ads are sent to mobile users located within a selected range from sponsor fulfillment station, whereby mobile app users in performance of some activity become motivated, triggering needs for vendor ad offerings while the user's need initiation and motivation is temporally and geographically proximate to the vendor for fulfillment of the mobile app user's needs.

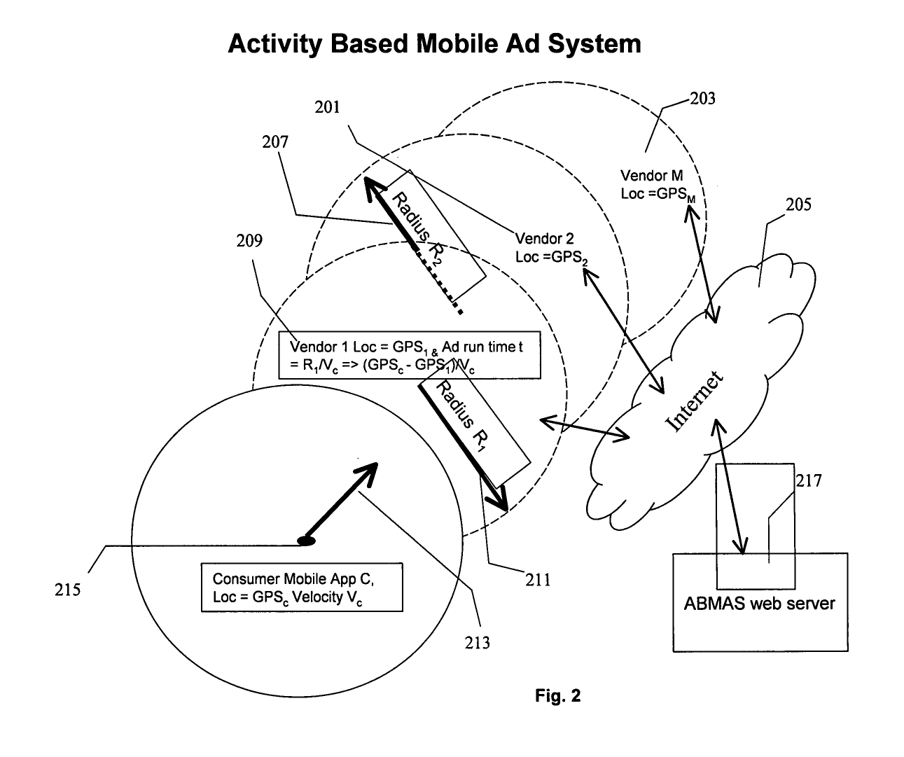

FIG. 2 shows exemplary mobile device user within proximity of local vendors and merchants bidding for ad placement on a mobile user's app for a selected period of time according to an embodiment of the present invention.

The duration that the mobile ad will run on a mobile device is an issue, after all the user 215 is only motivated until they reach a decision after which time they will attempt to implement their decision or choice. An object of the invention is to send ad's to mobile user's who are motivated to receive the ad information. This is more challenging because he mobile user 215, also consumer of the ad, can be mobile or stationary while executing an app. An aspect of the invention provides that the duration of an ad's display, or run time, can be a selectable parameter adjusting for the mobile users movement as well as location.

The time period of the ad's run can also be adjusted to or based on the users 215 average velocity 213. As the mobile user approaches vendors 209 201 203 which are all bidding for the user's 215 app space, the user's velocity can be calculated by obtaining Lat-Lon position using any of the available technologies including user's 215 sent GPS position, Wireless network-estimated, Cell triangulation, accelerometer or other sensor methods and combinations. Communication transpires from and identified biddable motivated user 215 across the Internet 205 and to the ABMAS server 217 through the ABMAS 217 API for the placement of vendor 209 201 203 ads at their bid priorities and selected time durations.

Once the ad consumer's average velocity is established, V_{c}, a radius of interaction or ad duration can be determined by the distance from the vender 209 to the consumer 215 divided by the consumer's velocity V_{c}. A consumer traveling on foot, at approximately 2 mph, may not need the same geographic distance for ad notification as a consumer 215 in a vehicle traveling at 60 mph as distance separation may preclude the consumer on foot from being a viable customer while not precluding the vehicle bound consumer. Vendors 209 201 203 are also distributed geographically and each may have a selected radius 211 of proximity at which time they wish the ad be sent to user 215 for an optimal ad run duration. These are all then programmable, as the consumers location and velocity are known, their mode of transportation factors into their viability as vendor customers as well as well as their activity indicating need for the vendors 209 201 203 product or service.

As an example for using selectable ad run time of 3 minutes is set. With this time radius a consumer traveling on-foot-3 mph, by bicycle-10 mph, or vehicle-60 mph would receive a mobile app ad from a vendor distance-radius of 0.15 mi, 0.5 mi and 3.0 miles respectively. Knowing a lat-lon location of an activity threshold triggering user 215 within an activity threshold bid winning vendor 209 lat-lon location determines a radius-distance from the user to the vendor. Thus simply arithmetically multiplying the users average velocity with the ad run time and accounting for units yields the radius distance from user to vendor during with time the mobile user app will run on the mobile ad, which factors in relative speed of the user to the vendor. An alternate overlapping vendor nearby will have a different radius-distance of ad run zone but a priority of ad send-vendor-que-ad-place hierarchy can be established based on radius distance, ad run duration, and vendor ad bid amount.

Thus a user time-radius for ad sponsor mobile ad send time is determined by multiplying the average velocity of the mobile by the selected interval of time such that the ad runs on the mobile during mobile user's proximity to ad vendor station for ad fulfillment and is commensurate with user mode of travel.

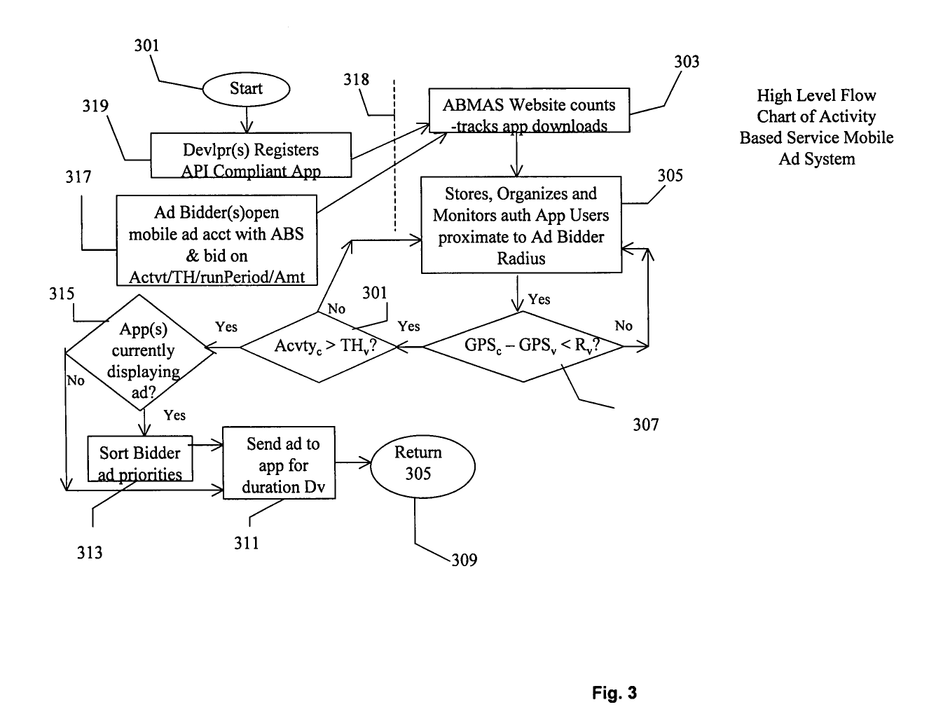

FIG. 3 is a flow diagram showing mobile app Activity Based Mobile App Service 303 process for collecting, storing 305 and using user activity data according to an embodiment of the present invention.

App developers will register 319 their ABMAS 303 API compliant apps with the ABMAS 303 service. As mobile app users download and use the apps, user app activity data in compliance with the ABMAS API is sent to the ABMAS 303 service. Mobile ad sponsors 317 register with the ABMAS 303 service vendor interface select sponsor parameters such as ads, vendor location, ad run-time, activities and thresholds of activities with bid amounts. This information is then stored 305 for real-time access and ad delivery by the ABMAS 303 service.

Authorized user positions are compared with participating sponsors 307 to determine if an app user is within a vendor location which can service users needs. If not within the sponsor's zone, other candidate mobile user's positions are retrieved 305. If a candidate mobile app user is found to within a sponsor's zone 307, then the app users sponsor's matching activity is checked for activity threshold 301 selected by sponsor. If the users activity exceeds the vendor's selected activity threshold 301, then the logic proceeds to check to see if the user already has an app actively displaying 315. If the sponsors has no competing bidders 311 then the sponsor's ad is sent to the user's app for display. If the vendor's bid has competing bids, bids on the same users app, then a priority is established by bid amount and sorted into hierarchy 313 for ad display priority. 311 for the duration ad run-time selected or derived. Logic flow returns 309 to examine the next potential customer. Thus the service process is essentially to identify GPSc app users within the vendor's zone defined by vendor's location GPSv and time-radius Rv, determined by the product of selected ad duration time Dv and app user's speed, Dv*Vc, which exceed a vendor's GPSv bid activity and threshold THv, before sending a mobile user the vendor's ad.

It can be implementation of design on whether “polled” or “event-driven” represents the data flow on mobile activity through and through the API. Where polled: the lower-layer software periodically asks the application if anything is new, in event-driven: the application informs the lower-layer software whenever something interesting happens. Embodiments of the invention can support either or both of these—at the option of the application when it registers with the ABMAS system—since event-driven is fundamentally more efficient, but the nature of some applications will be such that they don't know have a reliable activity event to always trigger when they have a timely update for ABMAS. There may also be Mobile OS specific constraints on how these are allowed but are implementation details.

The times at which the certain ABMAS entity functions perform are asynchronous. The dotted line 318 demarking this separation shows that app developers 319 function to register their apps with the ABMAS 303 upstream of the operational functions of the ABMAS which logically follow. Ad sponsor bidders 319 also function upstream of the operational side of monitoring user apps where they wish to win bids on user app ads as represented by their position to the left of the real-time operational time dotted line 318 demarking their asynchronicity and the upstream position in the data flow.

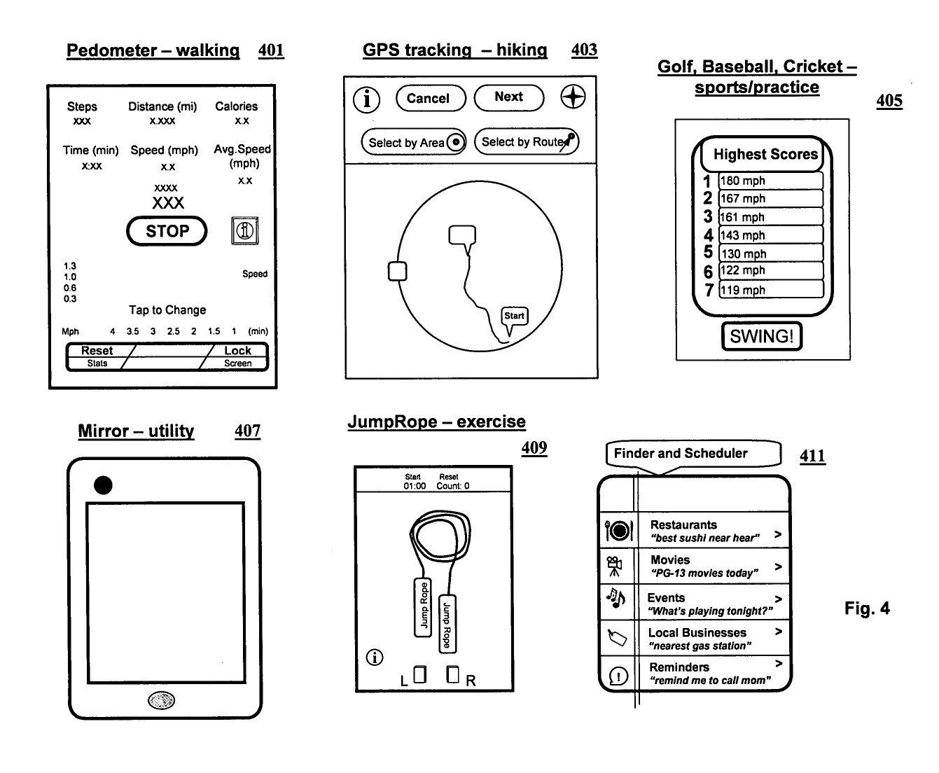

FIG. 4 is a diagram showing example mobile apps and their associated user interfaces for providing sensed activity data to the user in according to an embodiment of the present invention.

Because most cell phones and smartphones are acquiring more and better sensors, most mobile apps will sense and register some type of user activity over and above the GPS 403 location sensor. The number of activity usable apps is large and growing with many app download libraries, utilities and use categories. Mobile app categories include and some example interface apps are shown for Sports 405, Exercise 409, Location-based 411, Utilities 407, Tools, Entertainment 411, Food 411, Toys, Planners/Schedulers, Browsers, Research Tools and Finders, Books/Publications and others.

These would include specific activities such as golf, baseball, cricket, tennis, hiking, jogging, running, walking, GPS tracking, GPS driving, jump rope, calisthenics/physical regimen, exercise, volley ball, table tennis, virtual mobile games, using a mirror, taking photos/videos, using compass or level, making measurements and the list of human activities that can be sensed is almost limitless. There are hundreds of thousands of mobile apps and sensed activities are multiples of that number. Examples of only some of those are:
Calories Expended: Cal/min, cal/hour, cal-total
Swings: Swings over X, swings/min, swings/hour, duration (Stop-Start)
Jumps: Jumps/hour, Jumps>x, Jumps-total duration
Activity Time-Duration: current-Start, x % of duration, interval
Distance: total traveled, per time period
Velocity: Avg. Instant Velocity, >X, <Y
Acceleration: Avg. Instant acceleration, >X, <Y
Teeth Health: color, alignment, gaps
Hits: hits/time, Hits >X, >Y, hits*duration, Hits total
Measurements: leveling, navigating, repetitive motion in working, impact loads,
Skin Care: color uniformity, blotches, acne, cuts, infections, cosmetics
Health Care: nose, eyes, hair anomalies or symptoms of problems
Virtual Team Sports: Group hits/time/holes/swings/
JPG/MPEGs: Horses eating, Pets playing, Sightseeing, Bird watching

App activities sensed by the apps offer a treasure trove of data suitable to discover user activities which would spawn user needs. These would include such parameters as: Golfing scores-swings-holes-game or duration, Base Ball swings-timing-velocity-hits-runs-innings, Cricket scores-hits, Tennis score-games-serve-velocity-duration, Hiking distance-time-velocity-route-waypoints, Jogging distance-time-velocity-route-waypoints, running distance-time-velocity-route-waypoints, Mirror use showing teeth-nose-skin-eye-ear problems, tool use and usage, GPS tracking distance traversed-route taken-time duration, GPS driving time in vehicle-distance traveled-, Jump Rope jumps-time duration, Volley Ball volleys-jumps-duration, table tennis swings-volleys, Virtual Mobile Game swings-throws-holes-distance-duration, Calories Expended per min-sec-hour-total, Swings: Swings over X, swings/min, swings/hour, duration (Stop-Start), Jumps: Jumps/hour, Jumps>x, Jumps-total duration, Activity Time (current-Start), Distance: total traveled, per time period, Velocity: Avg. Instant Velocity, >X <Y, Acceleration: Avg. Instant acceleration, >X, <Y, Activity Duration, Hits: hits/time, Hits >X, >Y, hits*duration, Hits total Group hits/time/holes/swings, number of measurements per time, teeth gaps, acne per square inch, retinal or lens anomalies, squints or squints per sec from a mirror app, app and app consults from a movie app, number of searches and so forth.

New apps are being developed continually, and old apps are being improved. Hence the number and names of apps and app activity is increasing. For example there is no app that uses a mirror app utility to run diagnostics and report facial health symptoms as yet. But a mirror utility app developer can use the optics and sensors to scan for certain facial features which are symptoms of problems handled by the medical or cosmetics community. Dentists may be interested in bidding on mirror app activities showing teeth that are yellow/stained/crooked/ or show skin care professionals may bid on mirror app collecting data on skin/acne/blotches/scars/jaundice/etc. Eye care professionals may be interested bidders on app user squinting or eyes with barely visible eye symptoms that only an eye doctor can recognize but a photo scan can identify symptoms. An app user may need to see an eye, nose, ear, skin doctor or dentist and not know it until reminded by a timely well placed ad. Ads of this nature may eventually looked upon as maintenance or health care notifies. However the activities and names for these are as yet unknown but can be accommodated by a flexible API interfacing the app developers, done at app creation time, with the AMBAS server and activities data, done at operational real-time.

Since the universe of human app sensing activities is increasing and predictably names of app activity is an open ended parameter, the auction engine would include functions to discover new activities which may be of interest to sponsors, new activities offered by newly introduced. Hence an embodiment of the invention API will allow for app developer chosen app activity names to be set at app creation and also used after user app download and use, for reporting the activity to the ABMAS app activity data in its auction interface. Having the activities growing and changing could also be facilitated by auction functions deriving and tracking activity metrics on the effectiveness of various activities and the ads displayed. A piece of the ad revenue would be a motivating factor for the app developer, that an income stream can be had as their app was used, and the more used the large the stream..

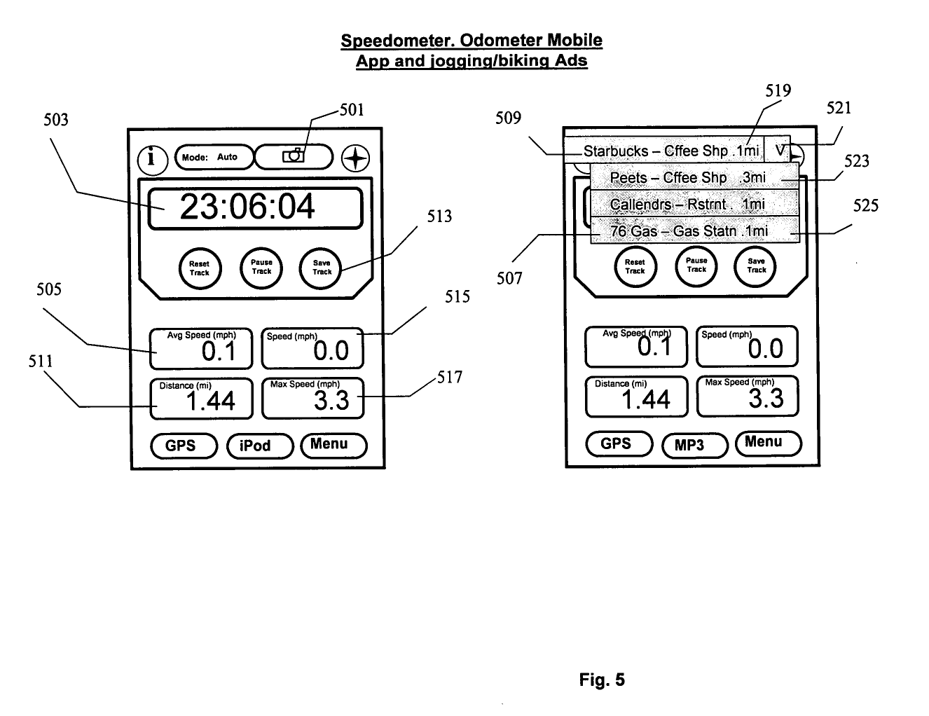

FIG. 5 is a diagram showing a hiker-biker tracker mobile app user interface and with an exemplar hierarchical mobile ad rendering according to an embodiment of the present invention.

The tracker app interface typically keeps track of the time 503, button to save treks 513 taken and stored, average speed 505, distance 511, maximum speed 517, speed 515, and other related useful utilities such as a camera 501. The activities that this app can supply to an interested sponsor are any of these and combinations. For example a coffee shop vendor or gas station thrift store may have interests in bikers or pedestrians that have traveled over 2 miles total and/or are in their vicinity during working 10 am-8 pm hours. The vendor interest would be based on their knowledge of their best customers and in this case the potential customer has walked more than 2 miles and is likely in need of some energizing beverage, lite desert and/or a place for respite. The bids would reflect those activity thresholds which would directly or indirectly spawn customer needs seeking to be fulfilled. The winning bidders ads would then be sent to the app users pedometer or tracker app with the winning bidder 509 most prominently displayed and perhaps some hierarchy commensurate with bid order displayed 507 below in a dropdown submenu or rolodex style with the associated distance to the vendors 519 523 525 as shown. Note the vendor order is determined by the bidding and not by distance, necessarily although many variations are possible.

The presentation of a hierarchy of ads on mobile display can be done in several ways, using drop down menus or rolodexing through user taps are some, and may depend on the mobile technology available to the app developer.

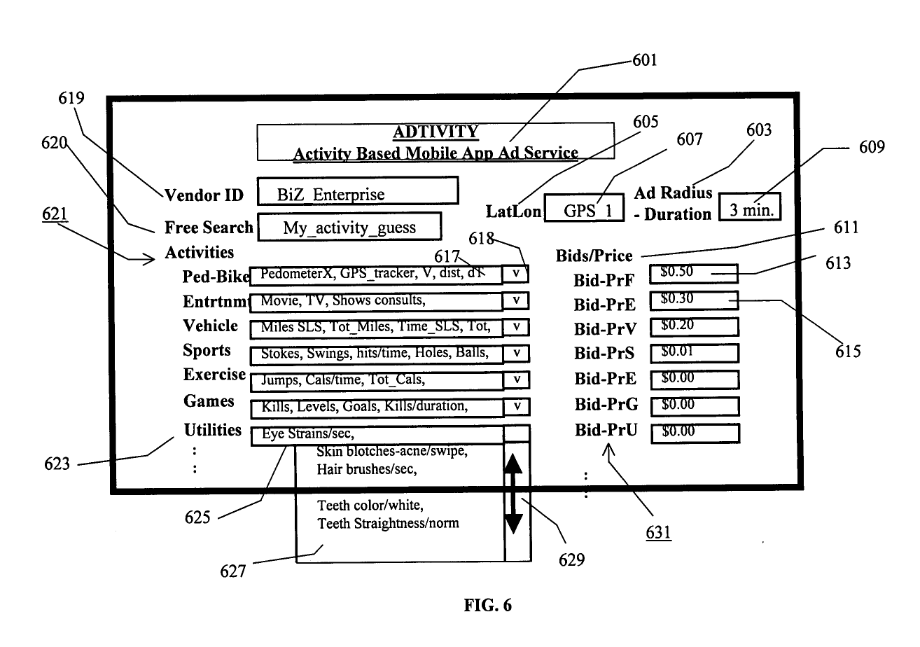

FIG. 6 is an exemplar vender ad sponsor interface for registering business information and placing activity bids on the model website according to an embodiment of the present invention.

Mobile ad sponsors register with the model 601 website and log into their account 619. Sponsors can search for activities generically 620, as the exact activity name may not fall into a set category or may be too new. Sponsors can also seek for activities in specific categories 621 and bid 611 accordingly. A search on the Utilities 623 category will provide activities offered by utilities. For example a mirror app 625 may provide a users 627 eye squints/sec, acne or skin blotches per inch, teeth color shades from white or teeth gap, thinning hairline or balding and more in a scroll down submenu 629. Sponsors select user activities which can be occur in series, bid 631 on a morning movie app consult 615 and current GPS track within 3 miles 613 of a vendor's movie theater or restaurant. Bids can be made on concurrent user activities, such as hiker traveling 613 a speed greater than 2 mph, has covered a distance of 5 miles and is consulting a compass app. Mining the activities space can be left in the hands of the sponsors and vendors, as they are most concerned and knowledgeable on their customers need generating activities and the strategies are as flexible as the imagination allows.

The sponsors fulfillment station location 605 is selected 607 so that vendor's ads can be based on an area of activity which is winding down or concluding within the Ad Radius 603 extending out from the vendor's fulfillment location 605 in a selected time duration 609. This is also cognizant of the potential customers mode of transportation and adjusts the ad-radius to the users speed in the vendors fulfillment zone. Hence the ad will be timely from the users need standpoint and timely from the users need fulfillment speed standpoint, two large transaction precluding logistic challenges combined to provide maximum user motivation to act on the sponsor ad to generate and consummate a transaction.

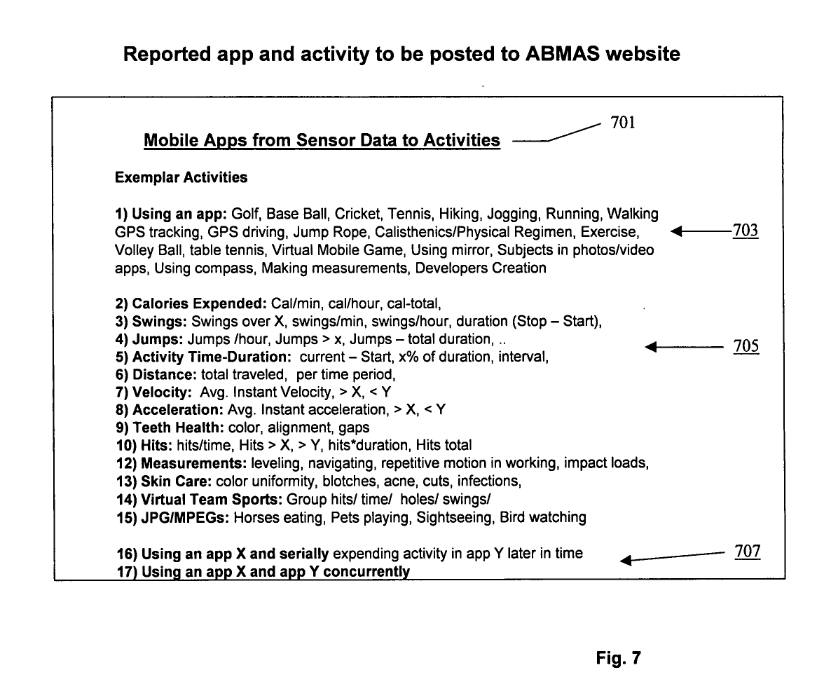

FIG. 7 is list of mobile sensor created mobile application activity which can be transmitted to a model website according to an embodiment of the present invention.

Mobiles are packing more and more sensors from Micro Electro Mechanical Systems, MEMS. MEMS take analog input—sound waves, light, temperature, movement, etc.—from and translate it into digital signals to which the processors running apps inside the mobile. These sensors include accelerometers, compasses, gyroscope, pressure sensors, proximity sensor, light sensors, capacitive touch sensors, microphones, and lenses. They enable mobile apps to read the signals and react and interact with the world around, and to translate the physical world into digital signals which processors running apps translate into activities 701.

In addition, there are aftermarket add-on sensors, for example though a dock connector extend the sensors to more external capabilities allowing reception of data from compatible fitness products including heart rate sensors, speed and cadence sensors, and weight scales. Thus sensed data creates a new space of representative activity which can be exploited in a distributed fashion by the present invention.

The act of executing an app can be an activity 703 and time stamping only makes that a more usable activity upon which to bid for mobile ad placement. Inside the apps many more activities 705 are possible and also serial or concurrent app 707 activities are also biddable activities.

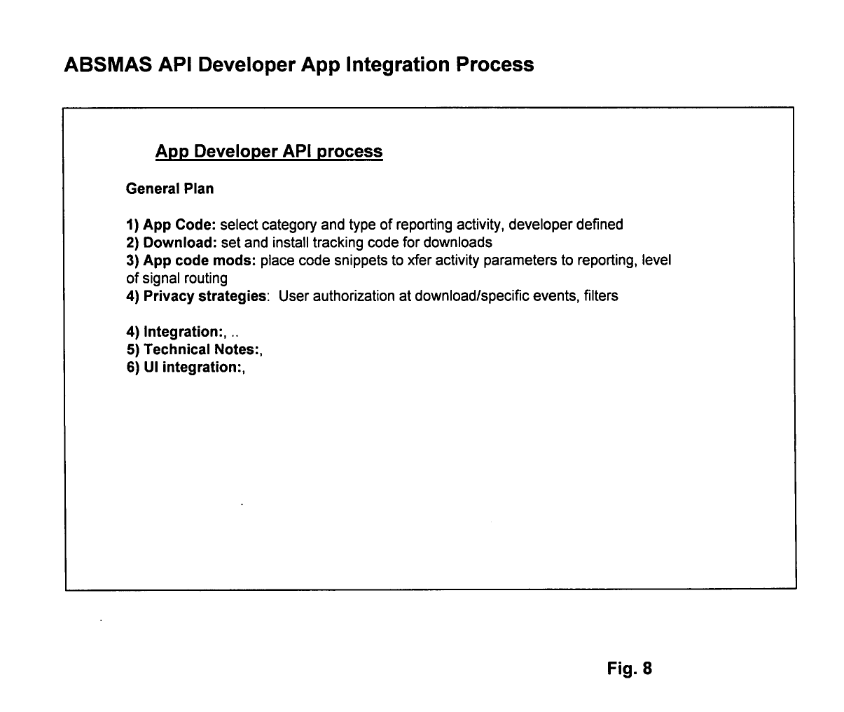

FIG. 8 is an exemplar API for mobile application creators for registering and integrating their apps with a model website according to an embodiment of the present invention.

The mobile app API can include such upload parameters as: Vendor App Unique ID, Activity Category: Golf, Base Ball, Cricket, Tennis, Hiking, Jogging, Running, Walking, Utilities, tools, GPS tracking, GPS driving, Jump Rope, Volley Ball, table tennis, Virtual Mobile Game, and virtually any activity that the app developer deems ad activity worthy.

Activities are generally app developer settable although there will be selectable activities included under categories for example Calories Expended: Cal/min, cal/hour, cal-total, Swings: Swings over X, swings/min, swings/hour, duration (Stop-Start), Jumps: Jumps/hour, Jumps>x, Jumps-total duration, Activity Time (current-Start), Distance: total traveled, per time period, Velocity: Avg. Instant Velocity, >X<Y, Acceleration: Avg. Instant acceleration, >X, <Y, Activity Duration, Hits: hits/time, Hits >X, >Y, hits*duration, Hits total Group hits/time/holes/swings, number of measurements per time, teeth gaps, acne per square inch, squints or squints per sec from a mirror app, app and app consults from a movie app, and so forth. Activity units are included as well and in some embodiments conversions between units can be auction provided functions.

Since activities are not all apriori known and are variable, diverse and increasing unpredictably, they need not be rigidly defined or excluded by rigidly specified structures in the API. The activity and category can be processed from available technology protocols and data exchange standards.

Privacy and user authorization are issues to be dealt with that are adjustable and selectable. Some embodiments may require the user's authorization. Other embodiments may allow the user settable ad fields. The app user may set up filters for prohibiting certain types of ads as they would always decline those offers and any ad from that source would be waste.

In some embodiments, that app developer API process and interface can be typical of existing mobile APIs used in ad models with the inclusion of app categories, app activities, privacy and ad filter options.

Therefore, while the invention has been described with respect to a limited number of embodiments, those skilled in the art, having benefit of this invention, will appreciate that other embodiments can be devised which do not depart from the scope of the invention as disclosed herein. Accordingly, the scope of the invention should be limited only by the attached claims. Other aspects of the invention will be apparent from the following description and the appended claims.

What is claimed is:

1. A system and Internet business model for coupling a plurality of mobile device applications sensing mobile user activity reaching thresholds perceived by mobile ad sponsors to be motivated customers in need of their products or services comprising:
a plurality of mobile device app developer registered mobile apps with an activity ad model API website;
the registered mobile apps downloaded to user mobile devices for execution;
user activity ad model API compliant apps reporting app data for at least one activity to activity ad API website;
the ad model website monitoring, receiving, storing and managing API registered mobile app activity over a geographical region covering the users;
a plurality of mobile ad sponsors setting bids on the mobile app selected activity levels at an ad model API auction server;
sponsor auction bid activity thresholds achieved by mobile app activities triggering an ordered hierarchy of sponsor ads to be sent to the mobile app user devices within the ad model API serving region at selected range from sponsor fulfillment station within the region,
whereby mobile app users in performance of app activity become motivated from triggered needs for vendor ad offerings, because the ad's display are more effective while the user's need initiation and motivation is temporally and geographically proximate to the vendor for fulfillment of the user's need.

2. A system as in claim 1 further comprising mobile applications from a set of mobile applications reporting activities consisting essentially of driving, walking, hiking, physical exercise, games, using tools, using utilities, sports and physical training, coaching, teaching, learning and combinations.

3. A system as in claim 1 further comprising determining the user time-radius for ad sponsor mobile ad send time by multiplying the average velocity of the mobile by the selected interval of time such that the ad runs on the mobile during mobile user's proximity to ad vendor station for ad fulfillment and is commensurate with user mode of travel.

4. A system as in claim 1 further comprising identifying higher sponsor bids after initial ad send to user for reordering a mobile ad display for ad display placement on the user's mobile.

5. A system as in claim 1 wherein a vendor activity threshold triggered ad which when clicked or triggered by app user provides at least the vendors name, category of offerings, approximate distance, address and a location from the user's location.

6. A system as in claim 1 further comprising locating API compliant mobile app users using mobile sensors, GPS, wireless hotspot, cell triangulation and general location basing technologies.

7. A system as in claim 1 further comprising sponsor bids on combinations of activities and of activity thresholds in series or concurrent.

8. A system as in claim 1 further comprising ad placement on mobile display using auction bid hierarchy.

9. A computer program residing on a computer-readable media, said computer program for:
developers registering mobile device app developer created mobile apps with the activity ad auction engine API;
users downloading API compliant apps to user mobiles and executing the apps;
executing apps for registering with the mobile ad auction engine and uploading at least one mobile app activity to engine;
ad website monitoring, receiving, storing and managing API registered mobile app activity at the mobile ad auction engine server;
setting mobile ad sponsor's bids on the mobile app selected activity levels at the mobile ad auction engine server;
sending triggered activity threshold winning sponsor ads to the mobile app user device for ad display, and
displaying mobile ads in sponsor time-radius to user location for ad to inform user of sponsor's product-service at user motivated time and location.

10. A method as in claim 9 further comprising the steps of registering mobile applications from a set of mobile applications reporting activities consisting essentially of driving, walking, hiking, physical exercise, games, using tools, using utilities, sports and physical training, coaching, teaching, learning and combinations.

11. A method as in claim 9 further comprising the steps of determining the user time-radius for ad sponsor mobile ad send time by multiplying the average velocity of the mobile by the selected interval of time such that the ad runs on the mobile during mobile user's proximity to ad vendor station for ad fulfillment and is commensurate with user mode of travel.

12. A method as in claim 9 further comprising the steps of identifying higher sponsor bids after initial ad send to user for reordering a mobile ad display for ad display placement on the user's mobile.

13. A method as in claim 9 further comprising the steps of displaying at least the winning ad sponsor's vendor name, category of offerings, approximate distance, address and a location from the user's location, when clicked or triggered by app user's mobile app.

14. A method as in claim 9 further comprising the steps of locating API compliant mobile app users using mobile sensors, GPS, wireless hotspot, cell triangulation and general location basing technologies.

15. A method as in claim 9 further comprising the steps of providing combinations of ad auction bid activities and of activity thresholds in series or in concurrency to bidding sponsors.

16. A method as in claim 9 further comprising the steps of ad placement on mobile display using auction bid hierarchy.

17. A method as in claim 9 further comprising the steps of ad placement on mobile display using auction bid hierarchy using drop down menus or rolodexing through user taps.
